(19) United States
(12) Patent Application Publication
(10) Pub. No.: US 2014/0179218 A1
(43) Pub. Date: Jun. 26, 2014

(54) Solar air handling unit

(71) Applicant: Meganine Industrial (Kunshan) Co., Ltd., Suzhou (CN)

(72) Inventor: Wu-Li Huang, Taichung (TW)

(73) Assignee: Meganine Industrial (Kunshan) Co., Ltd., Suzhou (CN)

(21) Appl. No.: 14/092,954

(22) Filed: Nov. 28, 2013

(30) Foreign Application Priority Data
Dec. 26, 2012 (CN) 201220726777.2

(51) Int. Cl. F24F 7/013; E06B 7/03

(52) U.S. Cl. CPC F24F 7/013; E06B 7/03
USPC 454/200

(57) ABSTRACT

A solar air handling unit (AHU) is provided with a fan; a support; and a solar voltaic module; wherein the support is provided with a vent; wherein the fan is disposed on the support; wherein an output of the fan directly communicates with an inlet of the support; wherein the solar voltaic module is disposed on the support; and wherein the solar voltaic module is configured to power the fan. The solar AHU is environmentally friendly.

### BACKGROUND OF THE INVENTION

1. Field of the Invention

The invention relates to air handling units (AHUs) and more particularly to a solar air handling unit having improved characteristics.

2. Description of Related Art

Convection can be classified as natural convection, forced convection and others. Natural convection occurs due to temperature differences which affect the density, and thus relative buoyancy, of the fluid. Heavier components will fall, while lighter components rise, leading to bulk fluid movement. It is not suitable for high convection requirement. In forced convection fluid movement results from external surface forces such as a fan or pump. Forced convection is typically used to increase the rate of heat exchange. However, energy consumption (i.e., electricity consumption) is required.

Thus, the need for improvement still exists.

### SUMMARY OF THE INVENTION

It is therefore one object of the invention to provide a solar air handling unit comprising a fan; a support; and a solar voltaic module; wherein the support is provided with a vent; wherein the fan is disposed on the support; wherein an output of the fan directly communicates with an inlet of the support; wherein the solar voltaic module is disposed on the support; and wherein the solar voltaic module is configured to power the fan.

Preferably, the solar voltaic module is at an angle of 15-degree to 45-degree with respect to a virtual vertical line.

Preferably, further comprising a shroud disposed on a surface of the support distal the fan for covering an exit; wherein the shroud includes a downward vent;

wherein the shroud and the surface of the support facing the downward vent are at an angle of 15-degree to 45-degree with respect to a virtual vertical line; and wherein the solar voltaic module is disposed on the shroud facing the vent of the support.

Preferably, further comprising a window blind disposed on the vent of the support.

Preferably, an exit of the window blind is at an inclined angle with respect to the downward vent of the shroud.

By utilizing the invention, the following advantages are obtained. It is environmentally friendly. A maximum air flow is obtained. No pollution. A best utilization of the sunlight is effected.

The above and other objects, features and advantages of the invention will become apparent from the following detailed description taken with the accompanying drawings.

### BRIEF DESCRIPTION OF THE DRAWINGS

FIG. 1 is a perspective view of a solar air handling unit according to the invention;

FIG. 2 is a top view of the support;

FIG. 3 is top view of the shroud;

FIG. 4 is a view taken along line A-A of FIG. 3; and

FIG. 5 is an environmental view of the solar air handling unit.

### DETAILED DESCRIPTION OF THE INVENTION

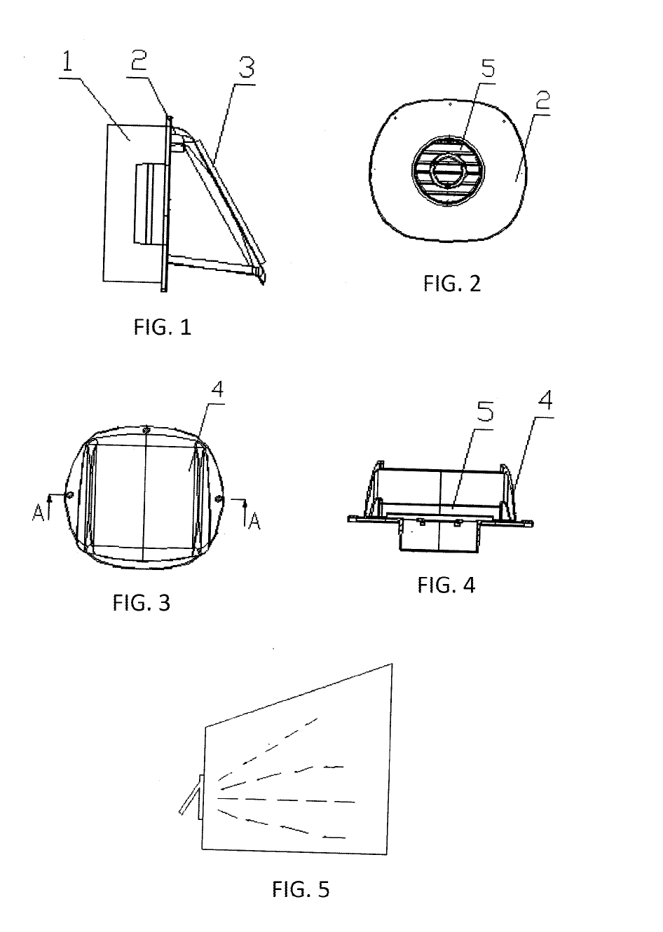

Referring to FIGS. 1 to 5, a solar air handling unit (AHU) in accordance with the invention comprises the following components as discussed in detail below.

A fan 1, a support 2, and a solar voltaic module 3 are provided. The support 2 is provided with vents. The fan 1 is provided on the support 2. Output of the fan 1 directly communicates with inlet of the support 2. The solar voltaic module 3 is provided on the support 2. The solar voltaic module 3 includes a plurality of solar cells being packaged and connected together. The solar cell is an electrical device that converts the energy of light directly into electricity by the photovoltaic effect. The electricity is supplied to the fan 1 which can blow for forced convection. It is envisaged by the invention that no external power is required.

The invention has the following benefits. One is convection. It is understood that best time of a day for absorbing sunlight is 10 AM to 16 PM. A fan 3 having 3 W power and a solar voltaic module 3 capable of supplying 12 volt electricity is taken as an exemplary example. A draught of 36 m³/hour can be effected and it is sufficient for a small house or office. The other is temperature conditioning. The convection of the AHU can change the air temperature and humidity within an area used for cooling.

The solar voltaic module 3 is tilted at an angle of 15-degree to 45-degree with respect to a vertical line for best absorbing sunlight.

The surface of the support 2 distal the fan 1 is provided with a shroud 4 for covering an exit. The shroud 4 has a downward vent. The shroud 4 and the surface of the support 2 facing the vent are at an angle of 15-degree to 45-degree with respect to a vertical line. The solar voltaic module 3 is provided on the shroud 4 and on a surface facing the vent of the support 2.

The exit of the support 2 is provided with a window blind 5. Exit of the window blind 5 is directed at an inclined angle with respect to an exit of the shroud 4.

While the invention has been described in terms of preferred embodiments, those skilled in the art will recognize that the invention can be practiced with modifications within the spirit and scope of the appended claims.

What is claimed is:

1. A solar air handling unit comprising:
a fan;
a support; and
a solar voltaic module;
wherein the support is provided with a vent;
wherein the fan is disposed on the support;
wherein an output of the fan directly communicates with an inlet of the support;
wherein the solar voltaic module is disposed on the support; and
wherein the solar voltaic module is configured to power the fan.

2. The solar air handling unit of claim 1, wherein the solar voltaic module is at an angle of 15-degree to 45-degree with respect to a virtual vertical line.

3. The solar air handling unit of claim 1, further comprising a shroud disposed on a surface of the support distal the fan for covering an exit; wherein the shroud includes a downward vent; wherein the shroud and the surface of the support facing the downward vent are at an angle of 15-degree to 45-degree with respect to a virtual vertical line; and wherein the solar voltaic module is disposed on the shroud facing the vent of the support.

4. The solar air handling unit of claim 1, further comprising a window blind disposed on the vent of the support.

5. The solar air handling unit of claim 4, wherein an exit of the window blind is at an inclined angle with respect to the downward vent of the shroud.
